(19) United States
(12) Patent Application Publication
(10) Pub. No.: US 2024/0200413 A1
(43) Pub. Date: Jun. 20, 2024

(54) REAL TIME SHOULDER POINT DETERMINATION IN THREADED CONNECTION MAKE-UP

(71) Applicant: WEATHERFORD TECHNOLOGY HOLDINGS, LLC, HOUSTON, TX (US)

(72) Inventors: David GEISSLER, Hannover (DE); Benjamin SACHTLEBEN, Hannover (DE); Rainer RUEHMANN, Hannover (DE); Christina HEBEBRAND, Hannover (DE)

(21) Appl. No.: 18/066,258

(22) Filed: Dec. 14, 2022

(51) Int. Cl. E21B 19/16; E21B 3/02; E21B 17/042; G05B 13/02

(52) U.S. Cl. CPC E21B 19/166; E21B 3/022; E21B 17/042; E21B 19/161; G05B 13/027; E21B 2200/22

(57) ABSTRACT

A method of controlling make-up of a threaded connection can include training an artificial intelligence, inputting data to the artificial intelligence during the threaded connection make-up, the artificial intelligence thereby determining a shoulder point during the threaded connection make-up, and controlling application of torque to the threaded connection, based in part on the determined shoulder point. A system for controlled make-up of a threaded connection can include a torque application device configured to apply torque and rotation to the threaded connection, and a control system comprising a controller and an artificial intelligence. The controller may be configured to control operation of the torque application device, and the artificial intelligence may be adapted to determine a shoulder point of the threaded connection during the make-up of the threaded connection.

### BACKGROUND

This disclosure relates generally to equipment utilized and operations performed in conjunction with a subterranean well and, in an example described below, more particularly provides for real time shoulder point determination in a threaded connection make-up process.

In general, threaded connections between tubulars installed in a well must be able to withstand a pressure differential without leaking, and must be resistant to unthreading in the well. For this reason, manufacturers of threaded tubulars typically specify that connections between the tubulars must be made-up in a particular manner. For example, a specification for a threaded connection might require that a certain number of turns (or range of turns) or a certain level of torque (or range of torque) must be applied to the threaded connection after the connection is shouldered-up.

Therefore, it will be appreciated that improvements are continually needed in the art of performing threaded connection make-up operations. The present specification provides such improvements to the art, which improvements may be utilized with various forms of threaded components, including but not limited to those known to persons skilled in the art as drill pipe, casing, liner and tubing.

### BRIEF DESCRIPTION OF THE DRAWINGS

FIG. 1 is a representative partially cross-sectional view of an example of a system and associated method which can embody principles of this disclosure.

FIG. 2 is a representative elevational view of a portion of the FIG. 1 system, depicting an example of a threaded connection being made-up.

FIGS. 3A & 3B are representative cross-sectional views of an example of the threaded connection at seal contact and shoulder points.

FIG. 4 is a representative graph of torque versus turns for an example of a threaded connection make-up.

FIG. 5 is a representative schematic diagram for another example of the system and method.

FIG. 6 is a representative schematic diagram for an example of a trainable artificial intelligence for use in the FIG. 5 system.

FIG. 7 is a representative schematic diagram for an example of a control system for use in the FIG. 1 or FIG. 5 system examples.

FIG. 8 is a representative schematic diagram for another example of the control system.

### DETAILED DESCRIPTION

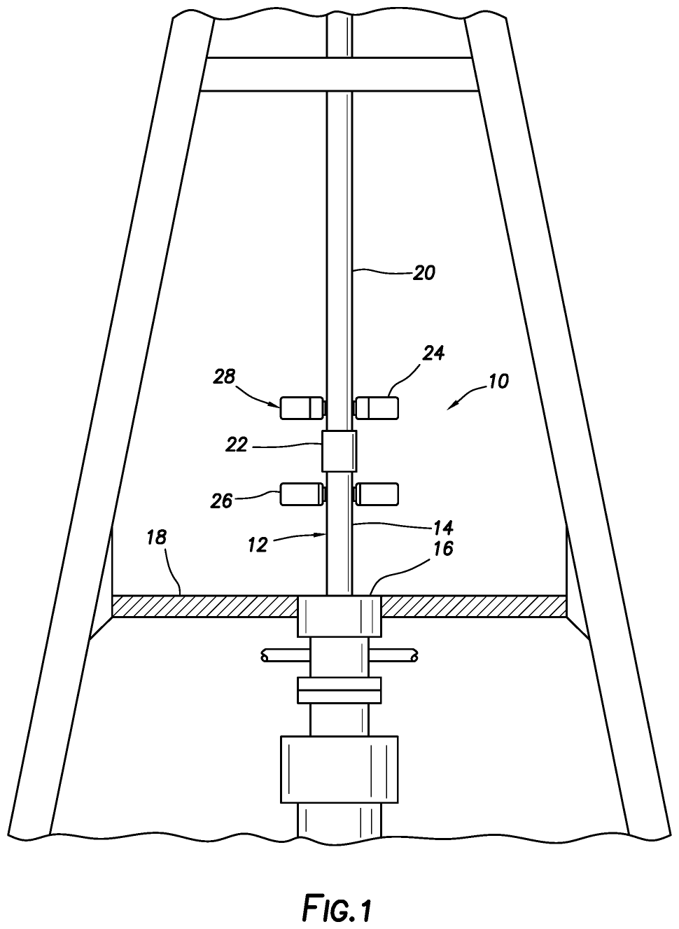

Representatively illustrated in FIG. 1 is a system 10 for making-up a threaded connection, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a tubular string 12 is being assembled and deployed into a well. The tubular string 12 in this example is a production or injection tubing string, but in other examples the tubular string could be a casing, liner, drill pipe, completion, stimulation, testing or other type of tubular string. The scope of this disclosure is not limited to use of any particular type of tubular string, or to any particular threaded components connected in a tubular string.

As depicted in FIG. 1, an uppermost tubular 14 of the tubular string 12 is suspended near its upper end by means of a rotary table 16, which may comprise a pipe handling spider and/or safety slips to grip the tubular 14 and support a weight of the tubular string 12. In this manner, the upper end of the tubular 14 extends upwardly through a rig floor 18 in preparation for connecting another tubular 20 to the tubular string 12.

In this example, a tubular coupling 22 is made-up to the upper end of the tubular 14 prior to the tubular 14 being connected in the tubular string 12. The coupling 22 is internally threaded in each of its opposite ends.

In conventional well operations, it is common for a threaded together tubular and coupling to be referred to as a “joint” and for threaded together joints to be referred to as a “stand” of tubing, casing, liner, pipe, etc. However, in some examples, a separate coupling may not be used; instead one end (typically an upper “box” end of a joint) is internally threaded and the other end (typically a lower “pin” end of the joint) is externally threaded, so that successive joints can be threaded directly to each other.

Thus, the scope of this disclosure can encompass the use of a separate coupling with a tubular, or the use of a tubular without a separate coupling (in which case the coupling can be considered to be integrally formed with, and a part of, the tubular). In the FIG. 1 example, the coupling 22 can also be considered to be a tubular, since it is a tubular component connected in the tubular string 12.

To make-up a threaded connection between the tubular 20 and the coupling 22, a set of tongs or rotary and backup clamps 24, 26 are used. The rotary clamp 24 in the FIG. 1 example is used to grip, rotate and apply torque to the upper tubular 20 as it is threaded into the coupling 22.

The backup clamp 26 in the FIG. 1 example is used to grip and secure the lower tubular 14 against rotation, and to react the torque applied by the rotary clamp 24. The rotary clamp 24 and the backup clamp 26 may be separate devices, or they may be components of a rig apparatus known to those skilled in the art as an “iron roughneck.”

In one example, the rotary clamp 24 and backup clamp 26 may be components of a torque application device 28, such as a tong system or an iron roughneck. In this example, the rotary clamp 24 may be a mechanism that rotates and applies torque to the upper tubular 20, and the backup clamp 26 may be a backup mechanism that reacts the applied torque and prevents rotation of the lower tubular 14. Thus, the term “rotary clamp” as used herein indicates the rotation and torque application mechanism, and the term “backup clamp” as used herein indicates the torque reacting mechanism.

Note that it is not necessary for the tubulars 14, 20 (and coupling 22, if used) to be vertical in the threaded connection make-up operation. The tubulars 14, 20 could instead be horizontal or otherwise oriented. Additional systems in which the principles of this disclosure may be incorporated include bucking systems for making up tubular joints prior to their use at a rig.

In other examples, a top drive (not shown) may be used to rotate and apply torque to the upper tubular 20. Thus, it will be appreciated that the scope of this disclosure is not limited to use of any particular equipment to grip, rotate, apply torque to, or react torque applied to, any tubular in a threaded connection make-up operation. The torque application device 28 may comprise a tong system, an iron roughneck, a bucking system, a top drive or any other device suitable for making-up a threaded connection.

After the upper tubular 20 is properly made-up to the lower tubular 14 or coupling 22, the tubular string 12 can be lowered further into the well, and the make-up operation can be repeated to connect another stand to the upper end of the tubular string. In this manner, the tubular string 12 is progressively deployed into the well by connecting successive stands to the upper end of the tubular string. In some examples, an individual threaded component may be added to the tubular string 12, instead of a tubular stand.

In the FIG. 1 method, the threaded connection make-up process can be controlled, so that a properly made-up connection is obtained, and this control can be automatic, so that human error is avoided. As described more fully below, the system 10 can include features that enable a shoulder point of the threaded connection to be determined in real time (while the threaded connection is being made-up) using an artificial intelligence element of the system 10, so that human error in determining the shoulder point can be avoided.

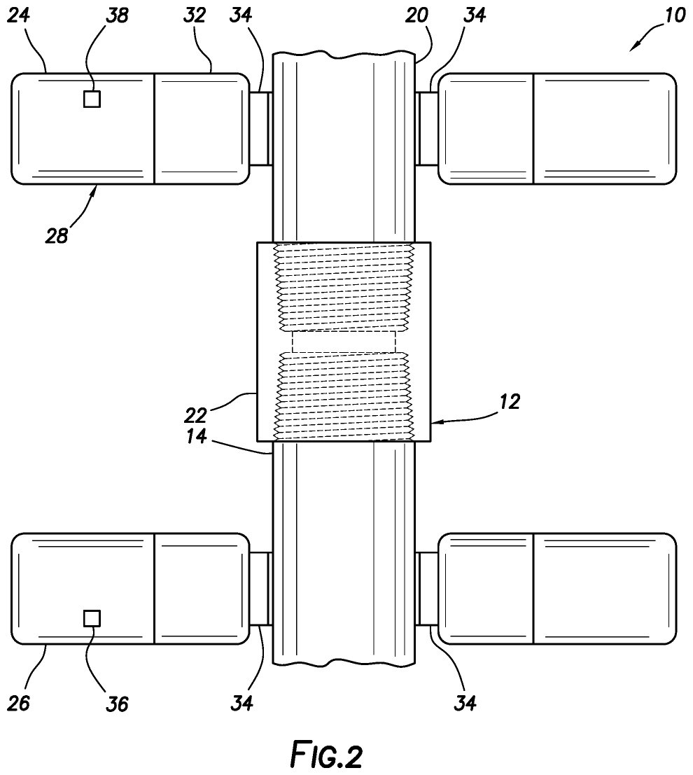

Referring additionally now to FIG. 2, a portion of the FIG. 1 system 10, depicting an example of a threaded connection being made-up, is representatively illustrated. For convenience, various examples of the method of making-up a threaded connection are described below as they may be used with the system 10 of FIG. 1, but the methods may be used with other systems in keeping with the principles of this disclosure.

As depicted in FIG. 2, the threaded connection make-up process is being performed. The tubular 20 is positioned above and axially aligned with the coupling 22, with the rotary clamp 24 appropriately positioned to grip an outer surface of the tubular 20. The backup clamp 26 grips an outer surface of the tubular 14 to react torque applied during the threaded connection make-up process.

The rotary clamp 24 in this example includes a rotation or turns sensor 38 that measures a quantity of turns applied to the upper tubular 20. Any type of sensor capable of outputting indications of rotation or turns (whether cumulatively or iteratively) in real time may be used for the sensor 38.

The backup clamp 26 in this example includes a torque sensor 36 that measures a level of torque applied to the threaded connection. Any type of sensor capable of outputting indications of torque in real time may be used for the sensor 36.

The upper tubular 20 is rotated by a rotor 32 of the rotary clamp 24. The rotor 32 is rotated by a motor (not shown) of the rotary clamp 24. Jaws 34 carried in the rotor 32 grip the outer surface of the tubular 20, thereby transmitting torque and rotation from the rotor to the tubular as the tubular is threaded into the coupling 22. If a top drive is instead used to rotate the tubular 20, then the rotor 32 could be a component (such as a quill) of the top drive mechanism that rotates with the tubular.

The backup clamp 26 also includes jaws 34 that grip the outer surface of the lower tubular 14 to react the torque applied by the rotary clamp 24 and thereby prevent rotation of the lower tubular. If a top drive is used to apply the torque and rotation to the upper tubular 20, then the jaws 34 may be part of a casing spider or another torque reacting device. In other examples, the jaws 34 may be part of a bucking unit.

It may be necessary in some examples for a predetermined torque or range of torque levels to be applied to the threaded connection, in order for the threaded connection to be considered acceptable for use in the well. In other examples, it may be necessary for a predetermined number of turns or range of turn values to be applied to the threaded connection after the threaded connection is shouldered-up. In any of these examples, it can be useful to determine the shoulder point (the point at which the threaded connection is shouldered-up) in real time while the threaded connection is being made-up, in order to make appropriate adjustments to the make-up operation (such as, adjustments to the torque application or rotational speed), to begin counting turns after the shoulder point, or for other purposes. The scope of this disclosure is not limited to any particular purpose for determining the shoulder point during make-up of a threaded connection.

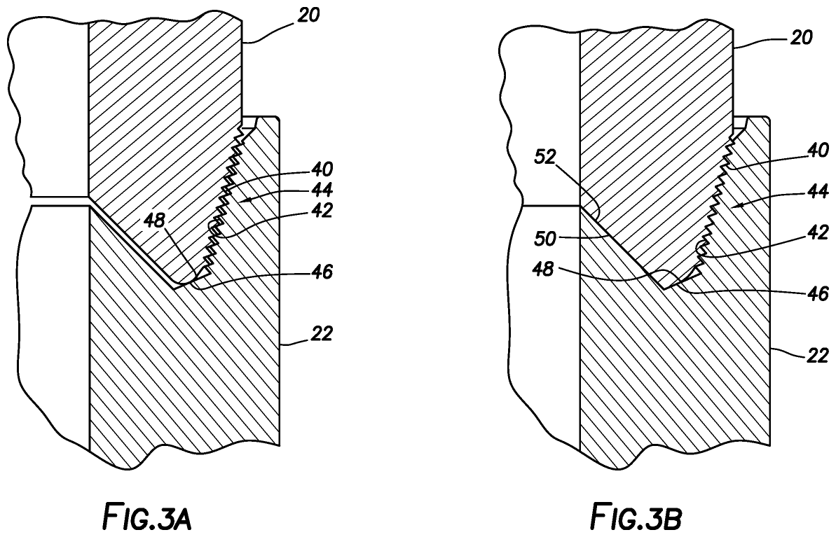

Referring additionally now to FIGS. 3A & B, cross-sectional views of an example of a threaded connection 44 are representatively illustrated. The threaded connection 44 may be used with the system 10 of FIG. 1, or other types of threaded connections may be used with the system 10.

In FIG. 3A, external tapered threads 40 on a lower end of the upper tubular 20 are engaged with internal tapered threads 42 in an upper end of the coupling 22, thereby forming the threaded connection 44. However, it should be clearly understood that the scope of this disclosure is not limited to any particular type of threaded connection formed between any particular type of threads on any particular types of threaded components.

In the FIG. 3A example, a lower seal end 46 of the upper tubular 20 is making contact with an internal seal surface 48 in the coupling 22. At this point, a minimal seal may be formed between the seal end 46 and the seal surface 48, but the threaded connection 44 is not fully made-up.

As depicted in FIG. 3B, further torque and rotation have been applied to the upper tubular 20, so that the upper tubular has advanced further into the coupling 22. As a result, the seal end 46 has deformed (the seal surface 48 may also be deformed somewhat), and an inclined shoulder 50 formed in the lower end of the upper tubular 20 abuts an inclined shoulder 52 formed in the upper end of the coupling 22. The deformation of the seal end 46 forms a pressure-tight seal with the seal surface 48.

At this point, the threaded connection 44 is shouldered-up, or at its shoulder point. The specification for the threaded connection 44 may require that further torque be applied to the connection, and/or that a certain number of additional turns of the upper tubular 20 be accomplished after the shoulder point, in order for the threaded connection 44 to be acceptable for use in the well.

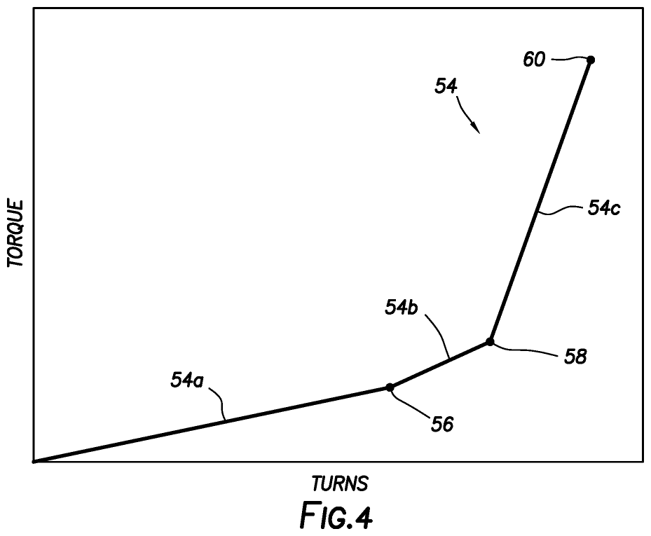

Referring additionally now to FIG. 4, an example graph 54 of torque versus turns for an example threaded connection is representatively illustrated. For convenience of description, the graph 54 is made up of substantially linear segments 54a-c, with each of the segments having a different slope. An actual graph of torque versus turns for an actual threaded connection will typically not include segments with such linearity, which can lead, for example, to errors in determining certain points represented in the graph.

The graph 54 is described below as it may represent the make-up of the FIGS. 3A & B threaded connection 44. However, the scope of this disclosure is not limited to any particular representation of the threaded connection 44 example of FIGS. 3A & B, or to any particular torque versus turns graph shape.

The segment 54a represents an initial threading of the upper tubular 20 into the coupling 22. Note that the applied torque gradually increases as the number of turns increases, but a slope of the segment 54a is relatively small.

Eventually, the seal end 46 of the upper tubular 20 contacts the seal surface 48 in the coupling 22. This seal contact point is represented in the graph 54 at point 56.

As mentioned above, further rotation of the upper tubular 20 after the seal end 46 contacts the seal surface 48 results in deformation of the seal end. Thus, due to this deformation of the seal end 46, the torque required to produce additional turns of the upper tubular 20 increases. Note the increased slope of the segment 54b (as compared to the slope of the segment 54a) after the seal contact point 56.

The further rotation of the upper tubular 20 after the seal contact point 56 eventually results in full contact between the shoulders 50, 52 of the upper tubular and the coupling 22. This shoulder point is represented in the graph 54 at point 58.

Still further rotation of the upper tubular 20 after the shoulder point 58 will be substantially resisted by the abutting contact between the shoulders 50, 52. Note the greatly increased slope of the segment 54c (as compared to the slopes of the segments 54a,b).

Eventually, the specification for the threaded connection 44 will be achieved at a point 60. For example, a certain minimum, optimal or range of torque will have been applied to the threaded connection 44, and/or a certain number of turns of the upper tubular 20 after the shoulder point 58 will have been achieved. At this point 60, the applied torque can be released (not shown in the graph 54).

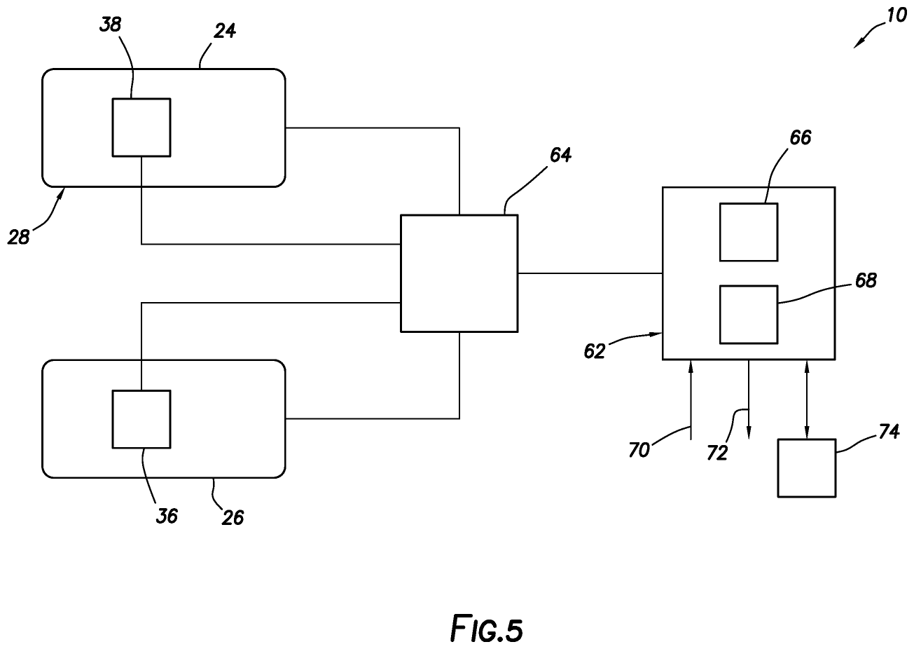

Referring additionally now to FIG. 5, a schematic diagram for another example of the system 10 and method is representatively illustrated. In this example, the system 10 includes a control system 62 for controlling operation of the torque application device 28. As depicted in FIG. 5, the torque application device 28 includes the rotary and backup clamps 24, 26, but in other examples a top drive, bucking unit, iron roughneck or other type of torque application device may be used.

In the FIG. 5 example, a tong remote unit 64 is used as an interface between the control system 62, the power and backup clamps 24, 26 and the sensors 36, 38 on or near the rig floor 18 (see FIG. 1). However, in other examples the tong remote unit 64 can be incorporated as part of the control system 62, or the tong remote unit may not be used (such as, if the torque application device is a top drive or a bucking unit).

As depicted in FIG. 5, the control system 62 includes at least a controller 66 and an artificial intelligence 68. In various examples, the control system 62 can also include one or more processors for executing instructions stored in memory, various types of input and output devices, databases, mathematical models, etc. The scope of this disclosure is not limited to any particular components, elements or combination thereof in the control system 62.

The controller 66 may be of the type known as a programmable logic controller. The controller 66 is suitably configured to control operation of the torque application device 28. For example, the controller 66 can be configured to control operation of the jaws 34 of the rotary and backup clamps 24, 26 (see FIG. 2), to control application of torque and rotation by the rotary clamp, to release the torque at the point 60 in the make-up process (see FIG. 4), etc. The scope of this disclosure is not limited to use of any particular type of controller, or to any particular function or combination of functions controlled by the controller.

Various inputs 70 may be provided to the control system 62 prior to, during or after the threaded connection make-up. For example, values for minimum, maximum and optimal torque levels, minimum, maximum and optimal turns after shoulder point, tubular component dimensions, thread type, job data, etc., may be input by an operator prior to commencement of the make-up operation. Indications of torque and rotation from the sensors 36, 38 are also inputs 70 to the control system 62 during the make-up operation.

Outputs 72 can be provided from the control system 62 prior to, during or after the threaded connection make-up operation. The outputs 72 can be displayed, printed, stored in memory, transmitted to a remote location via Internet or satellite, etc. In a typical drilling operation, outputs 72 from the control system 62 can be provided to a driller's console, and inputs 70 from the driller's console (e.g., to initiate a threaded connection make-up, to terminate a threaded connection make-up, etc.) may be provided to the control system.

In the FIG. 5 example, an external storage device 74 is connected to the control system 62. The storage device 74 may be local or remote (or both), and may be used to record any relevant data before, during or after the threaded connection make-up process.

The artificial intelligence 68 is trained to determine the shoulder point 58 in real time (during the threaded connection make-up). The training of the artificial intelligence 68 may be performed before the threaded connection make-up, for example, using data samples from previous jobs or from techniques used to generate data samples (such as, by using a generative adversarial network). The training of the artificial intelligence 68 may be performed, at least in part, during the threaded connection make-up, for example, using real time data (such as, the indications of torque and turns from the sensors 36, 38), including shoulder point determination data from prior threaded connections made-up on the same job.

The determined shoulder point 58 can be provided by the artificial intelligence 68 to the controller 66 for use in controlling the operation of the torque application device 28. For example, if the specification for the threaded connection 44 requires that a predetermined number of turns be achieved after the shoulder point 58, the controller 66 can count the number of turns that are achieved after the determined shoulder point and, when the predetermined number of turns is achieved, the controller can operate the torque application device 28 to release the applied torque. As another example, if it is desired to reduce the rotational speed of the upper tubular 20 after the shoulder point 58 (e.g., to make it easier to accurately apply an optimal torque), the controller 66 can operate the torque application device 28 to reduce the rotational speed after the shoulder point, and then release the applied torque when the optimal torque is achieved. However, the scope of this disclosure is not limited to use of the determined shoulder point 58 by the controller 66 in any particular manner or to achieve any particular result.

In some examples, it may be desirable to determine the shoulder point 58 prior to the shoulder point being achieved during make-up of a threaded connection 44. Using the FIG. 4 graph 54 for explanation purposes only, the artificial intelligence 68 may be trained so that it can, during the segment 54b of the graph, predict or estimate where the shoulder point 58 will occur (e.g., at what torque level, number of turns and/or time). This will enable the controller 66 to control the operation of the torque application device 28 in response to the determined shoulder point 58, for example, by regulating the rotational speed of the upper tubular 20 or the rate of application of torque by the rotary clamp 24.

In some examples, the artificial intelligence 68 may be trained to determine the shoulder point 58 after the shoulder point has been achieved. For example, it may take some time for the indications of torque and turns from the sensors 36, 38 to be received and processed by the control system 62, so that the shoulder point 58 is determined by the artificial intelligence 68 at a point in time after the shoulder point is achieved. However, the determination of the shoulder point 58 after it is achieved is still useful information, since the controller 66 can use this information to count the number of turns that are accomplished after the determined shoulder point, and can use this information to control the application of torque in any remaining portion of the threaded connection make-up process.

In some examples, the artificial intelligence 68 may be trained to determine the shoulder point 58 using data obtained during prior threaded connection make-up processes on the same job. It is expected that, as long as the pipe dimensions, threads, torque application device, etc., have not changed on the same job, the prior determined shoulder points will provide useful predictions of shoulder points for subsequent threaded connections. The artificial intelligence 68 training process can weight the prior shoulder point determinations accordingly.

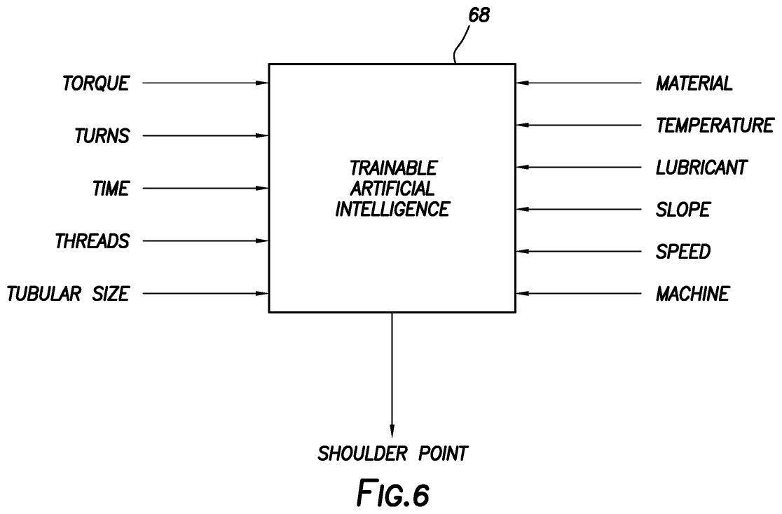

Referring additionally now to FIG. 6, a schematic diagram for an example of a trainable artificial intelligence 68 that may be used with the FIG. 5 control system 62 is representatively illustrated. The artificial intelligence 68 may be used with other control systems in keeping with the scope of this disclosure.

FIG. 6 depicts examples of data that may be used to train the artificial intelligence 68, and/or that may be input in real time in order to determine the shoulder point 58 in a threaded connection make-up operation. As depicted in the FIG. 6 example, these data include torque applied to the threaded connection 44, turns of a component of the threaded connection, time since initiation of the threaded connection, the threads 40, 42 (e.g., thread type and size), tubular 20 size, a material of which the threaded components are made, ambient temperature and/or other environmental data, any lubricant applied to the threaded connection, slopes (e.g., of the torque/turns graph segments 54a-c), rotational speed, and the particular machine used for the torque application device 28.

As mentioned above, the data used to train the artificial intelligence 68 may be derived from past jobs, in which case a known shoulder point 58 for each past threaded connection make-up (for example, as determined by an expert) can be compared to the shoulder point initially predicted/estimated by the artificial intelligence 68, and then parameters (such as, mathematical “weights”) of the artificial intelligence can be adjusted to minimize any difference between the known and estimated shoulder points. This training process can be repeated in an iterative loop, until the difference between the known and estimated shoulder points is acceptably small. A similar training technique may be used with generated or synthetic data. The trained artificial intelligence 68 can then be incorporated into the control system 62.

The training of the artificial intelligence 68 can continue after it is incorporated into the control system 62. The data available to the control system 62 during a threaded connection make-up operation can be used to further train the artificial intelligence 68 during the operation. As mentioned above, prior shoulder point determinations and related data obtained can be used to train the artificial intelligence 68 to predict the shoulder point for subsequent threaded connections on the same job.

Various types of artificial intelligence may be used alone or in combination in the control system 62. Suitable types of artificial intelligence include, but are not limited to, neural networks, Kalman filters and other types of recursive filters, and genetic algorithms.

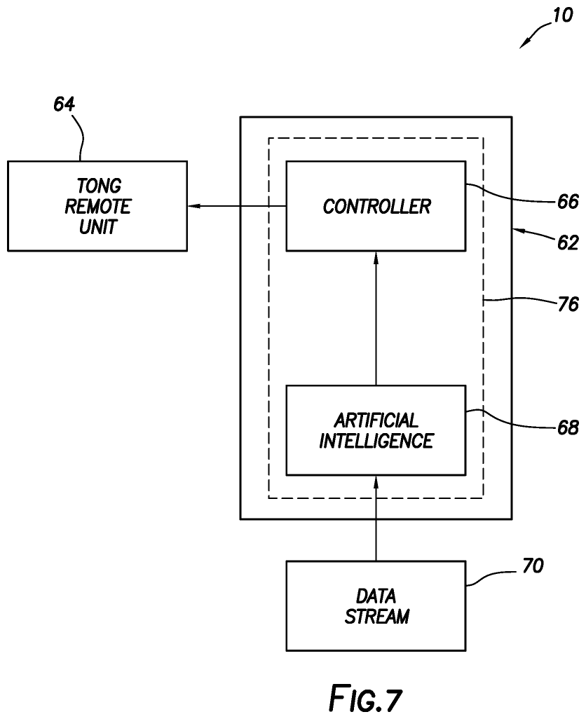

Referring additionally now to FIG. 7, a schematic view of another example of the control system 62 is representatively illustrated. The control system 62 is depicted in FIG. 7 as it may be used in the FIG. 1 system 10 and method, but the control system 62 may be used with other systems and methods in keeping with the scope of this disclosure.

In the FIG. 7 example, the control system 62 includes a real time operating portion 76, in which the states of the controller 66 and the artificial intelligence 68 change during the make-up of a threaded connection 44. The operational state of the controller 66 changes in real time, for example, in order to control the operation of the torque application device 28 via the tong remote unit 64 during the threaded connection make-up, as described above.

The artificial intelligence 68 also changes in real time, in this example, in that training of the artificial intelligence continues during the threaded connection make-up, as described above. The inputs 70 to the control system 62 include a real time data stream comprising, for example, the torque and turns indications received from the sensors 36, 38, time, temperature and speed indications, and prior shoulder point determinations made on the same job. The real time training of the artificial intelligence 68 can include adjusting mathematical weights of the artificial intelligence, in order to minimize any differences between shoulder points 58 predicted by the artificial intelligence and actual shoulder points identified, for example, by an experienced operator.

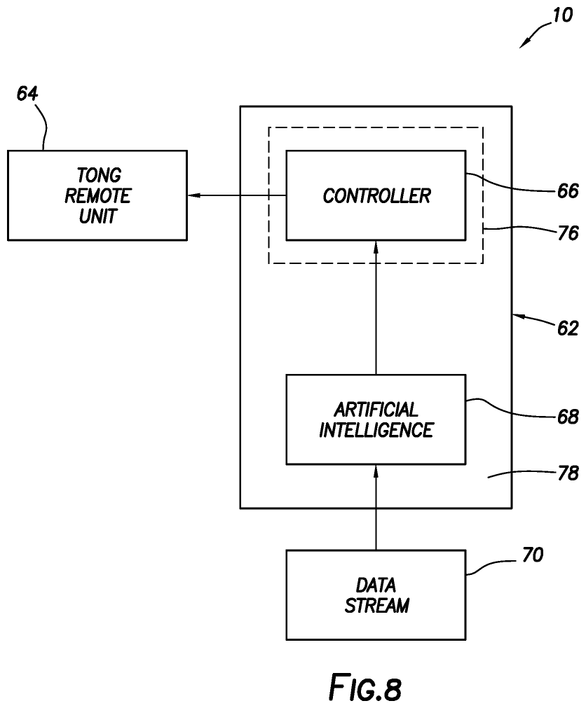

Referring additionally now to FIG. 8, a schematic view of another example of the control system 62 is representatively illustrated. In this example, the controller 66 operates in the real time operating portion 76 of the control system 62, but the artificial intelligence 68 operates in a non-real time operating portion 78 of the control system.

In the FIG. 8 example, the artificial intelligence 68 is trained prior to the threaded connection make-up operation, and then the trained artificial intelligence is incorporated into the control system 62. The artificial intelligence 68 is not further trained in real time during the threaded connection make-up operation. However, the artificial intelligence 68 may be further trained in an offline operation after conclusion of the threaded connection make-up operation, and then incorporated into the control system 62.

It may now be fully appreciated that the above disclosure provides significant benefits to the art of making-up threaded connections for use in a well. In examples described above, a shoulder point of a threaded connection can be determined in real time by an artificial intelligence during make-up of the threaded connection, thereby mitigating human error in the determination of the shoulder point.

The above disclosure provides to the art a method of controlling make-up of a threaded connection 44. In one example, the method can comprise: training an artificial intelligence 68; inputting data to the artificial intelligence 68 during the threaded connection make-up, the artificial intelligence 68 thereby determining a shoulder point 58 during the threaded connection make-up; and controlling application of torque to the threaded connection 44, based in part on the determined shoulder point 58.

The training step may be performed prior to the threaded connection make-up. The training step may be performed at least in part during the threaded connection make-up.

The artificial intelligence 68 may comprise at least one of a neural network and a Kalman filter.

The shoulder point determining step may include determining, prior to the shoulder point 58, at least one parameter level that will be achieved at the shoulder point 58. The parameter may comprise at least one of torque, turns and time.

The shoulder point determining step may include determining at least one parameter level achieved after the shoulder point 58. The parameter may comprise at least one of torque, turns and time.

A control system 62 may comprise the artificial intelligence 68 and a controller 66 configured to control operation of a torque application device 28. The determined shoulder point 58 may be output from the artificial intelligence 68 to the controller 66. The controlling step may include the controller 62 controlling the operation of the torque application device 28.

The artificial intelligence 68 may be incorporated in a real time operating portion 76 of the control system 62. The artificial intelligence 68 may be incorporated in a non-real time operating portion 78 of the control system 62.

The training step may comprise inputting to the artificial intelligence prior shoulder point determinations for make-up of prior threaded connections. The prior shoulder point determinations may be from the same job, or prior jobs with similar conditions (e.g., same or similar tubular dimensions, threads, environmental conditions, and/or torque application device, etc.).

The training step may comprise: inputting data samples to the artificial intelligence 68; outputting estimated shoulder points 58 from the artificial intelligence 68; comparing the estimated shoulder points 58 to actual shoulder points for the data samples; and adjusting at least one parameter (such as, a mathematical weight) of the artificial intelligence 68 to minimize a difference between the estimated shoulder points 58 and the actual shoulder points 58.

Also provided to the art by the above disclosure is a system 10 for controlled make-up of a threaded connection 44. In one example, the system 10 can comprise: a torque application device 28 configured to apply torque and rotation to the threaded connection 44; and a control system 62 comprising a controller 66 and an artificial intelligence 68. The controller 66 may be configured to control operation of the torque application device 28. The artificial intelligence 68 may be adapted to determine a shoulder point 58 of the threaded connection 44 during the make-up of the threaded connection 44.

The system 10 may include a torque sensor 36. The artificial intelligence 68 may be adapted to receive torque indications from the torque sensor 36 during the make-up of the threaded connection 44. The artificial intelligence 68 may be adapted to learn from the torque indications received during the make-up of the threaded connection 44.

The system 10 may include a turns sensor 38. The artificial intelligence 68 may be adapted to receive turns indications from the turns sensor 38 during the make-up of the threaded connection 44. The artificial intelligence 68 may be adapted to learn from the turns indications received during the make-up of the threaded connection 44.

The artificial intelligence 68 may be adapted to output estimated shoulder points 58 in response to input of example data to the artificial intelligence 68 prior to the make-up of the threaded connection 44.

The torque application device 28 may comprise a rotary clamp 24 or a top drive.

The artificial intelligence 68 may be adapted to determine, prior to the shoulder point 58, at least one parameter level that will be achieved at the shoulder point 58. The parameter may comprise at least one of torque, turns and time.

The artificial intelligence 68 may be adapted to determine at least one parameter level achieved after the shoulder point 58. The parameter may comprise at least one of torque, turns and time.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of controlling make-up of a threaded connection, the method comprising:
training an artificial intelligence;
inputting data to the artificial intelligence during the threaded connection make-up, the artificial intelligence thereby determining a shoulder point during the threaded connection make-up; and
controlling application of torque to the threaded connection, based in part on the determined shoulder point.

2. The method of claim 1, in which the training is performed prior to the threaded connection make-up.

3. The method of claim 1, in which the training is performed at least in part during the threaded connection make-up.

4. The method of claim 1, in which the artificial intelligence comprises at least one of the group consisting of a neural network and a Kalman filter.

5. The method of claim 1, in which the determining further comprises determining, prior to the shoulder point, at least one parameter level that will be achieved at the shoulder point, the parameter comprising at least one of the group consisting of torque, turns and time.

6. The method of claim 1, in which the determining further comprises determining at least one parameter level achieved after the shoulder point, the parameter comprising at least one of the group consisting of torque, turns and time.

7. The method of claim 1, in which a control system comprises the artificial intelligence and a controller configured to control operation of a torque application device, in which the determined shoulder point is output from the artificial intelligence to the controller, and in which the controlling comprises the controller controlling the operation of the torque application device.

8. The method of claim 7, in which the artificial intelligence is incorporated in one of the group consisting of a real time operating portion of the control system and a non-real time operating portion of the control system.

9. The method of claim 1, in which the training comprises inputting to the artificial intelligence prior shoulder point determinations for make-up of prior threaded connections.

10. The method of claim 1, in which the training comprises:
inputting data samples to the artificial intelligence;
outputting estimated shoulder points from the artificial intelligence;
comparing the estimated shoulder points to actual shoulder points for the data samples; and
adjusting at least one parameter of the artificial intelligence to minimize a difference between the estimated shoulder points and the actual shoulder points.

11. A system for controlled make-up of a threaded connection, the system comprising:
a torque application device configured to apply torque and rotation to the threaded connection; and
a control system comprising a controller and an artificial intelligence, the controller being configured to control operation of the torque application device, and the artificial intelligence being adapted to determine a shoulder point of the threaded connection during the make-up of the threaded connection.

12. The system of claim 11, further comprising a torque sensor, and in which the artificial intelligence is adapted to receive torque indications from the torque sensor during the make-up of the threaded connection.

13. The system of claim 12, in which the artificial intelligence is adapted to learn from the torque indications received during the make-up of the threaded connection.

14. The system of claim 11, further comprising a turns sensor, and in which the artificial intelligence is adapted to receive turns indications from the turns sensor during the make-up of the threaded connection.

15. The system of claim 14, in which the artificial intelligence is adapted to learn from the turns indications received during the make-up of the threaded connection.

16. The system of claim 11, in which the artificial intelligence is adapted to output estimated shoulder points in response to input of example data to the artificial intelligence prior to the make-up of the threaded connection.

17. The system of claim 11, in which the artificial intelligence comprises at least one of the group consisting of a neural network and a Kalman filter.

18. The system of claim 11, in which the torque application device comprises one of a rotary clamp and a top drive.

19. The system of claim 11, in which the artificial intelligence is adapted to determine, prior to the shoulder point, at least one parameter level that will be achieved at the shoulder point, the parameter comprising at least one of the group consisting of torque, turns and time.

20. The system of claim 11 in which the artificial intelligence is adapted to determine at least one parameter level achieved after the shoulder point, the parameter comprising at least one of the group consisting of torque, turns and time.
